(19) United States
(12) Patent Application Publication
(10) Pub. No.: US 2011/0138339 A1
(43) Pub. Date: Jun. 9, 2011

(54) SMART TREE NAVIGATION

(76) Inventors: RICHARD WEBSTER, Richmond (CA); PHILLIPP ZIEGLER, Vancouver (CA)

(21) Appl. No.: 12/633,807

(22) Filed: Dec. 9, 2009

(51) Int. Cl. G06F 3/048

(52) U.S. Cl. 715/854

(57) ABSTRACT

Described herein are methods and systems for smart tree navigation. According to one aspect, the user inputs in the form of node interaction events are tracked to determine preferred nodes that can be used to guide a user's navigation in the future. In another aspect, the preferred nodes are suggested to a user for further navigation by visualization representations that emphasize the preferred nodes.

### FIELD OF THE INVENTION

The invention relates to navigation in user interfaces. More precisely, the invention relates to user navigation in tree structures of data based on past usage.

### BACKGROUND OF THE INVENTION

Hierarchies are commonly used to navigate and organize large volumes of data stored in documents. For example, a file system consists of trees of directories containing files. A source control repository organizes its resources into trees. Email clients may have a tree of folders to hold the individual emails. A business organization arranges its employees into reporting trees. A report groups the data on a number of fields, forming a tree of group instances. While the tree structure enables more efficient navigation of data than a flat structure, it may still be cumbersome to navigate through a number of levels in the tree to access a desired resource. In a large tree structure, a user may frequently access only small portions of the structure on a regular basis. The user may repeatedly navigate level-by-level to the same area of the tree. Users can explicitly create shortcuts to commonly used file system folders. Also, many applications keep track of a sample list of most-recently accessed files.

### SUMMARY OF THE INVENTION

Various embodiments of computer implemented methods and systems for smart tree navigation based at least in part on previous usage are described herein. In one embodiment, the method includes receiving user input as a node interaction event in a node of a tree structure of user interface components and determining one or more preferred nodes based at least in part on a hit count indicative of a number of times the node has been accessed in the past, and a time of the most recent access of the node. The method also includes navigating the user to the one or more preferred nodes.

In another embodiment of the invention, the system includes a navigation module to navigate a user in tree structures of data and one or more memory devices, the memory devices having stored thereon instructions related to the navigation module. The system also includes a processor in communication with the memory to execute the instructions in the memory related to the navigation module and navigation storage to store data indicative of the tree node interactions by the user.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a graphical user interface diagram with an exemplary illustration of guided user navigation through auto-expanding portions of a tree structure.

FIG. 2 is a graphical user interface diagram with an exemplary illustration of guided user navigation in tree structures through re-ordering portions of a tree structure to give preference to selected nodes.

FIG. 3 is a graphical user interface diagram with an exemplary illustration of guided user navigation based on preference through suggesting a list of nodes from a sublevel of a tree structure.

FIG. 4 is a graphical user interface diagram with an exemplary illustration of guided user navigation in tree structures through auto-completing partial paths entered by the user.

FIG. 5 is a flow diagram describing a method of navigating a tree structure of user interface (UI) components based on trends noted in past navigations.

FIG. 6 illustrates an exemplary list of data entries for tree node access.

FIG. 7 illustrates an exemplary list of data entries for a tree node and calculating a score of preference for sub-trees of the tree node.

FIG. 8 is a block diagram of an embodiment of the invention for a computer system for guided user navigation of a tree structure of UI components based on trends noted in past navigations.

### DETAILED DESCRIPTION

Embodiments of techniques for smart tree navigation are described herein. In the following description, numerous specific details are set forth to provide a thorough understanding of embodiments of the invention. One skilled in the relevant art will recognize however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

By keeping track of a user's previous access to items in a given tree, guidance can be given to future navigation in the tree. Several characteristics describing the nature of the past accesses can be used to guide future accesses. For instance, tree structure items that have been accessed more frequently and/or more recently are likely to be of more interest to the user. So, such items could be given more prominence and a user may be guided to such items. This could also allow previous users to guide subsequent users by providing specific clues in the user interface to reduce the burden of navigation. Expiration mechanisms can be used to cull the history of past accesses to capture only the latest or the most relevant tendencies to guide future accesses.

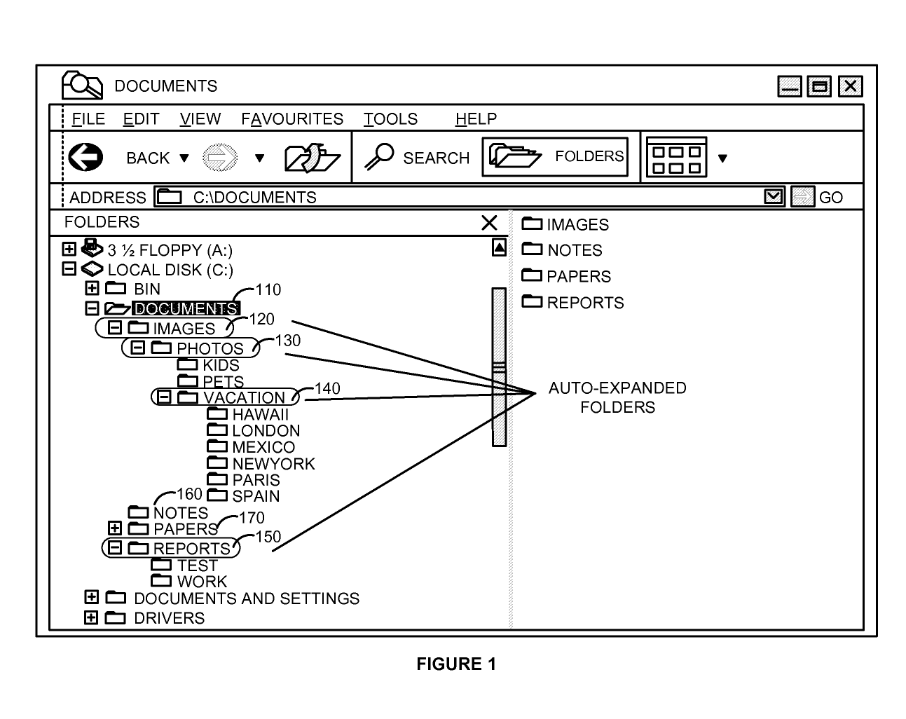

FIG. 1 represents guided user navigation through auto-expanding portions of a tree structure. When the user starts navigation from an upper node, like ‘documents’ 110, some portions of the sublevels might be auto-expanded to lead the user to the preferred nodes. In the example of FIG. 1, such auto-expanded nodes are the folders ‘images’ 120, ‘photos’ 130, ‘vacation’ 140, and ‘reports’ 150. In contrast, the folders ‘notes’ 160 and ‘papers’ 170 remain unaffected. This guidance could happen when initially displaying the tree or when the user interacts with a node in the tree. In one embodiment, a limit may be imposed on the number of nodes that are suggested for further navigation or on the depth of auto expansion. This could allow the efficient use of limited screen space and result in better user interaction.

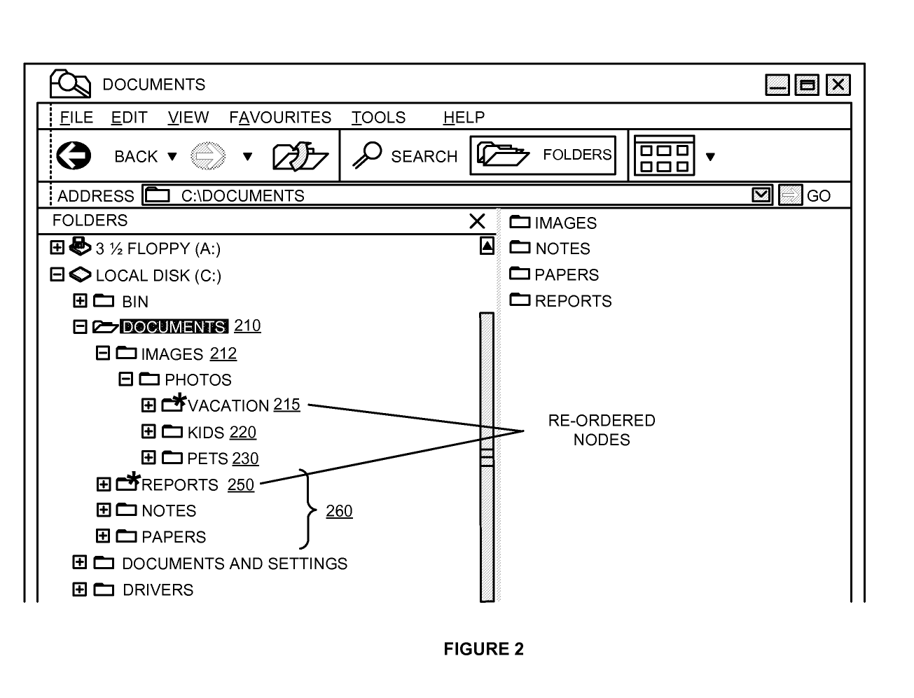

FIG. 2 illustrates another embodiment of presenting suggested nodes for further navigation where some portions of the tree structure are re-ordered to give preference to selected nodes. According to one embodiment, highly preferred parts of the tree are listed first. For example, when navigation starts from the node ‘documents’ 210, usually the subordinate nodes are displayed alphabetically. In some embodiments, the preferred nodes ‘vacation’ 215 and ‘reports’ 250 are re-ordered to be presented on the top of their sublevels. In some embodiments, the re-ordered nodes may be marked with special icons to indicate their significance. Thus, the node ‘vacation’ 215 is presented before node ‘kids’ 220 and node ‘pets’ 230, while typically the node ‘vacation’ 215 would stay on the bottom. The same is true with the node ‘reports’ 250 that is presented at the top of the group of nodes 260. At the same time, the node ‘reports’ 250 does not appear above the node ‘images’ 212, because the node ‘vacation’ 215 (images→photos→vacation) is preferable than the node ‘reports’ 250. Determining which nodes are to be re-ordered is again based on finding the most preferred nodes. In some embodiments, to avoid confusing the user, a selected number of nodes in a given tree could be re-ordered. In some embodiments, nodes selected to be re-ordered should be presented at the start of the list in descending order of preference. The remaining nodes should be left in their original order. One of ordinary skill in the art will recognize that other forms of ordering are possible.

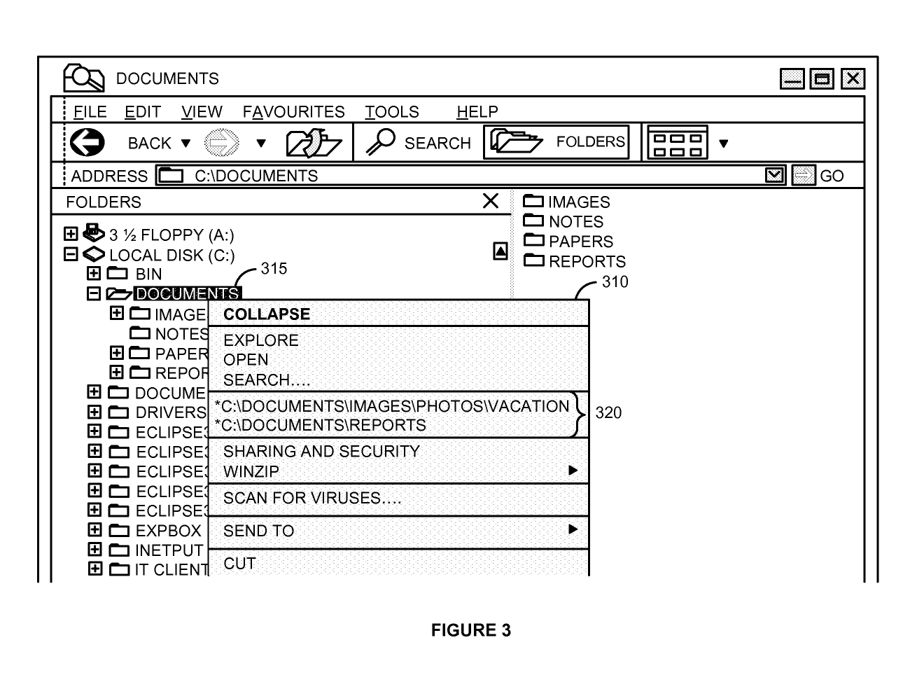

In yet another embodiment, guiding a user navigation based on preference is by suggesting a list of nodes from a sublevel as presented in FIG. 3. To guide the user directly to the most accessed nodes in some part of the tree, the user interface could display links to the most preferred nodes. This could take the form of a context menu 310 containing links 320 displayed in the user interface. Selecting one of these links 320 would allow a user to navigate directly to the specified node residing a number of levels below the original location documents 315.

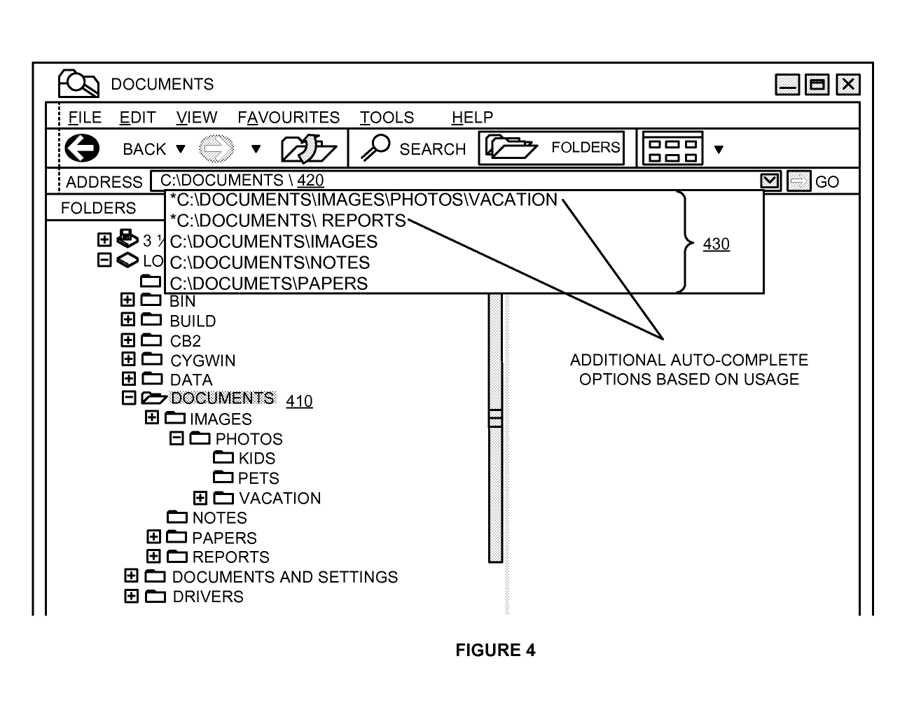

FIG. 4 illustrates yet another embodiment for guiding user navigation. For instance, if a user types a path for navigation, the user is offered guidance in the form of auto-completion based on the current tree position documents 410 and the partial path 420 typed by the user. In addition to showing the user navigation options 430 based on pattern matching of the partial path 420 to the values of tree nodes at the current location, the node access data could be used to also provide options for navigation to the most preferred nodes under each of these matching nodes provided by navigation options 430. So the nodes directly matching the pattern of characters typed so far in the partial path 420 may be determined first. Then for each of these determined nodes, the most preferred nodes provided by navigation options 430 are determined and combined into a list displayed to the user ordered by preference.

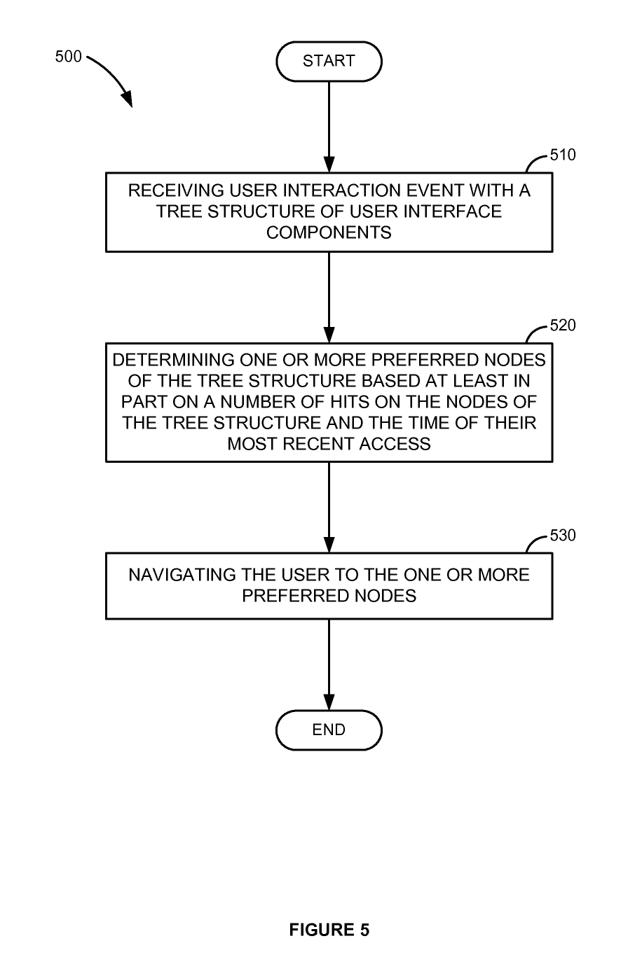

FIG. 5 represents a flow diagram 500 describing a method of navigating a tree structure of UI components based on trends noted in past navigations. The method starts at block 510 by receiving user input as a node interaction event in a node of a tree structure of user interface components. In one embodiment, the interaction event comprises presenting content of the node for a predefined period of time or interacting with data items belonging to the node. An interaction is ascertained based on a user viewing, accessing (e.g., opening, selecting via a UI device) or manipulating the node content for a predefined period of time. Such a time period suggests that the user is interested in the content of the node and his or her interaction with this node is not accidental. The time periods may be defined based on the type of the content that the nodes represent. The aim is to exclude cases when a user simply expands a node to see the descendant nodes or clicks through this node to get to child nodes. So, based on factors including the content type represented by the tree structure, whether a user interaction is meaningful can be determined by any number of factors including the duration of the access, on whether it was an access or just a selection, and whether any data was changed and so on. For instance, in one embodiment, the interaction event is opening the data item if the data item is a file.

Turning back to FIG. 5, the next step 520 of the navigation method is determining one or more preferred nodes based at least in part on a hit count indicative of a number of times the node has been accessed in the past, and a time of the most recent access of the node. So the preferred nodes are determined based on a hit count (e.g., number of meaningful interactions with the node in the past) and the time of the most recent access. Data needed to determine the preferred nodes should be stored. Thus, when a node access is detected, the node access data will be updated. If an entry already exists for the node, then its hit count will be increased and its last access time will be set to the current time. If no entry exists for the node, then a new one will be added with an initial hit count of one and the current time as the last access time. From the accumulated tree node access data, it is possible to look-up the most accessed nodes in the tree or some sub-trees. This information could be used to assist the user to perform commonly-performed navigation operations in the tree.

In order to determine which nodes in the tree are most likely to be significant for tree navigation, a formula is needed to quantify the preference or significance associated with a given tree node entry in the data. The higher the score for a given tree node, the more significant it is likely to be for navigation. A tree node that was frequently accessed years ago, but not since, should not be given a preference. Similarly, a node that has recently been accessed for the first time should not be given preference over one that has been accessed more frequently. So in one embodiment, the score, which may also be called score of preference, should increase with increasing hit count and should decrease as the most recent access time fades into the past. Different scoring formulae may better fit for certain applications, but a simple exemplary one is:

score=hit_count/age

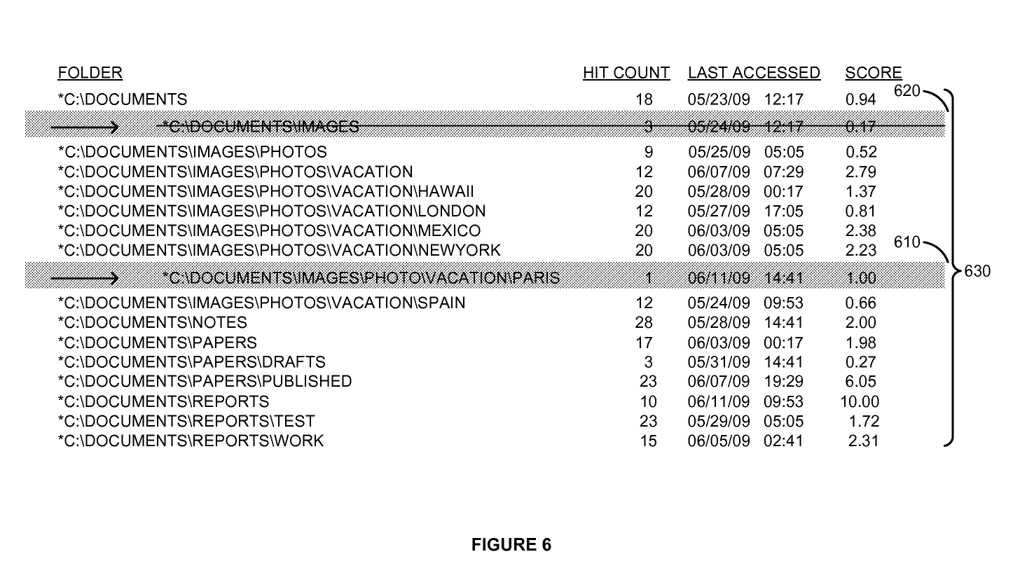

age=max(1, DiffInDays(CurrentTime, last_access_time))
where DiffInDays(time1, time2) returns the time interval between two time periods as a fractional number of days (positive if time1>time2).
   The scoring values will change slowly over time as the current time changes. Instead of repeatedly calculating the score, it may be sufficient to compute these once for some selected interval of time. In another embodiment, the score may be calculated whenever node access data is updated. The preferred nodes in a tree can be determined by scanning the node data items and calculating the scores for each. Typically, only a small number of results may be needed. So in one embodiment, the highest scoring nodes are tracked. Preferably, the tree access data is saved in a format that allows efficient look-up of entries for any sub-tree of the tree. In one embodiment, an ordered list based on the node path strings is used. Thus data about nodes from the same sub-tree is stored consecutively. In some embodiments this data is stored in a disk or memory. In order to prevent the data from growing disproportionately, a capacity limit may be specified. Once the data exceeds a given threshold, for example a threshold number of stored node entries, then the least significant data may be removed. The least significant data may be selected based on the node entries with the lowest score values. For example, in FIG. 6, the incoming node entry 610 leads to the removal of node entry 620 which has the lowest score from all entries 630.

Turning back to FIG. 5, at 530 the user is navigated to the most preferred nodes determined in 520. The user is assisted to reach the most preferred nodes by different visual representations of the tree structure, modified to emphasize the preferred nodes, thus guiding the user's future navigation. The navigation may be according to one of the approaches described with reference to FIGS. 1, 2, 3, and 4, which are auto-expanding portions of the tree, re-ordering portions of the tree, suggesting a list of nodes from a sub-tree, and auto-completing partial paths entered by the user.

The most preferred nodes in a tree may be found by scanning the node data items and calculating the scores for each. By sorting the data by the node path names, the items for a given sub-tree may be stored contiguously, and this block of items may be efficiently located using a binary search. As a result, finding the most preferred nodes in a sub-tree may be done by scanning a range of the data items.

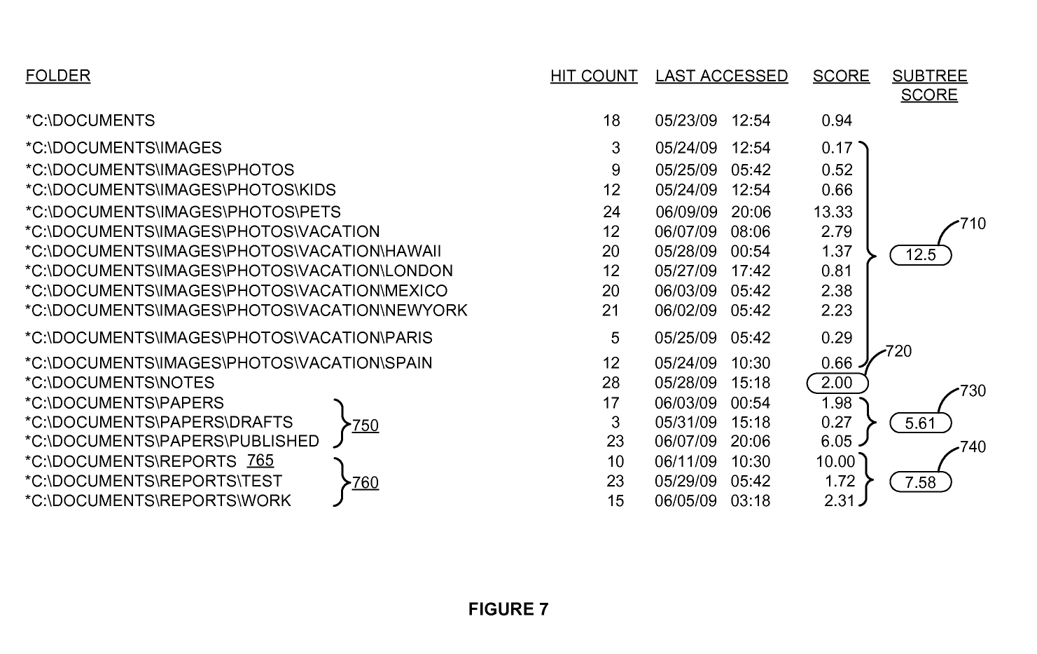

In one embodiment, as shown in FIG. 7, instead of looking for individual nodes with the highest scores, sub-trees with high aggregate scores are determined. For example, a sub-tree 750 that has a number of frequently accessed nodes may be of interest over another sub-tree 760 which contains a node 765 that is highly accessed. This can be achieved by computing a score across all the nodes in a sub-tree, such as using the formula:

subtree_score=SUM(hit_count)/AVG(age)

For example, the subtree score 730 for the subtree 750 is calculated as:

subtree score 730=SUM(17+3+23)/AVG(4,11,8)=43/7.67=5.61

In the example, the current date for the calculation of AVG(age) in days is taken as Jun. 11, 2009.

In one embodiment it is determined which child nodes of a given node, if any, represent a sub-tree that is highly accessed. For example, “C:\Documents” on a file system might have several subdirectories, and it may be useful to know, that nearly all access is under the “C:\Documents\images” directory. For that purpose, the aggregate scores 710, 720, 730, and 740 for all sub-trees starting at each child node are computed and then those nodes which have scores that are dominant of the total of the scores across the child nodes are selected. A suggested criterion is:

child_score>SUM(child_scores)/(Nmax+1),

where Nmax is the maximum number of nodes to select.

In FIG. 7, if two nodes are the maximum to be selected (Nmax=2), according to the criterion above, only score 710 has value 12.5 higher than 9.23 (score 710+score 720+score 730+score 740)/3. One of ordinary skill in the art will recognize that other criteria for defining dominant nodes are possible.

In one embodiment, stored access data may come from the interaction of multiple users. Thus, the navigation assistance may be based on what all users in a system have done. For example, in a global web site for e-commerce of fruit and vegetables that is accessed 24 hours round-the-clock by customers, the majority of the customers are accessing the web site during their day time. Customers in different time zones have different purchasing preferences, for example, customers from Germany buy a lot of potatoes, while customers from Mexico buy a lot of pineapples. If only German customers are accessing the tree, the guidance will lead to, for example, all→vegetables and vegetables→potatoes nodes. As the number of German customers declines and the number of Mexican customers increases, the guided tree nodes will be all→vegetables, vegetables→potatoes, and fruit→pineapples. Eventually, when the number of Mexican customers dominates, the guided tree nodes will be switched to all→fruit, fruit→pineapples, and vegetables→potatoes.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable medium as instructions. The term “computer readable medium” should be taken to include a single medium or multiple media that stores one or more sets of instructions. The term “computer readable medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

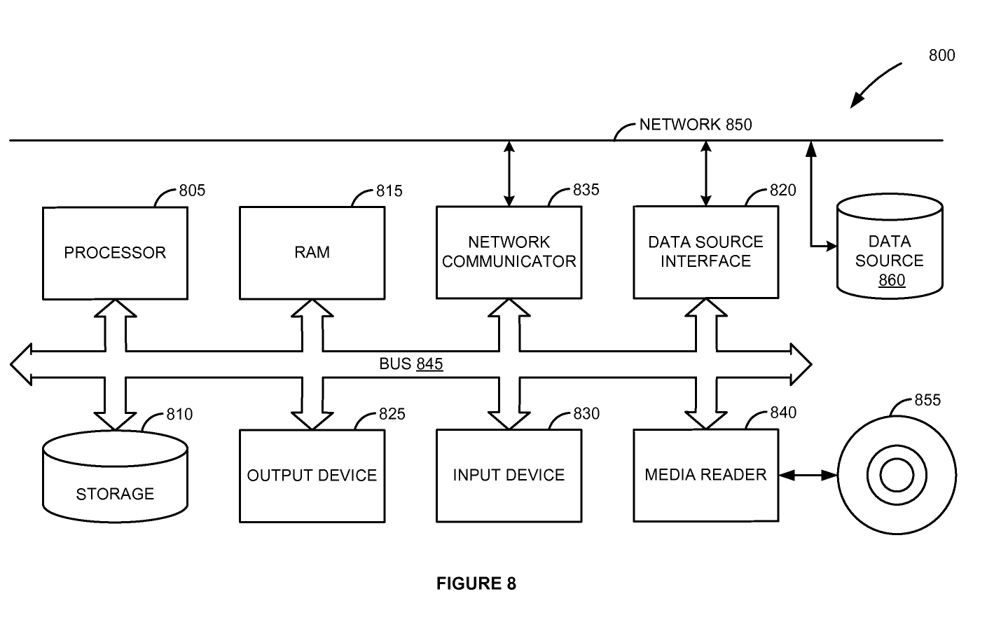

FIG. 8 is a block diagram of an exemplary computer system 800. The computer system 800 includes a processor 805 that executes software instructions or code stored on a computer readable medium 855 to perform the above-illustrated methods of the invention. The computer system 800 includes a media reader 840 to read the instructions from the computer readable medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be access via one or more abstraction layers implemented in hardware or software. For example, the data source 860 may be accessed through network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC) produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer readable medium comprising computer readable instructions, which, when executed by a computer, cause the computer to perform a method, the method comprising:
receiving user input as a node interaction event in a node of a tree structure of user interface components;
determining one or more preferred nodes based at least in part on a hit count indicative of a number of times the node has been accessed in the past, and a time of the most recent access of the node; and
navigating the user to the one or more preferred nodes.

2. The medium of claim 1, wherein a node interaction event comprises presenting content of the node for a predefined period of time or interacting with data items belonging to the node.

3. The medium of claim 2, wherein interacting with the data items belonging to the node includes opening the data item.

4. The medium of claim 1, wherein navigating the user to the one or more preferred nodes comprises auto-expanding portions of the tree.

5. The medium of claim 1, wherein navigating the user to the one or more preferred nodes comprises reordering portions of the tree.

6. The medium of claim 1, wherein navigating the user to the one or more preferred nodes comprises suggesting a list of nodes from a sub-tree.

7. The medium of claim 1, wherein navigating the user to the one or more preferred nodes comprises auto-completing partial paths entered by the user.

8. A computer implemented method of user navigation, the method comprising:
receiving user input as a node interaction event in a node of a tree structure of user interface components;
determining one or more preferred nodes based at least in part on a hit count indicative of a number of times the node has been accessed in the past, and a time of the most recent access of the node; and
navigating the user to the one or more preferred nodes.

9. The method of claim 8, wherein a node interaction event comprises presenting content of the node for a predefined period of time or interacting with data items belonging to the node.

10. The method of claim 9, wherein interacting with the data items belonging to the node includes opening the data item.

11. The method of claim 8, wherein navigating the user to the one or more preferred nodes comprises auto-expanding portions of the tree.

12. The method of claim 8, wherein navigating the user to the one or more preferred nodes comprises reordering portions of the tree.

13. The method of claim 8, wherein navigating the user to the one or more preferred nodes comprises suggesting a list of nodes from a sub-tree.

14. The method of claim 8, wherein navigating the user to the one or more preferred nodes comprises auto-completing partial paths entered by the user.

15. A computer system for user navigation, comprising:
a navigation module to navigate a user in tree structures of data;
one or more memory devices, the memory devices having stored thereon instructions related to the navigation module;
a processor in communication with the memory to execute the instructions in the memory related to the navigation module; and
a navigation storage to store data indicative of the tree node interactions by the user.

16. The system of claim 15, wherein the navigation module navigates a user in tree structures of data to sub-trees that have higher aggregate score of preference than other sub-trees.

17. The system of claim 15, wherein the navigation module navigates a user in tree structures of data through auto-expanding portions of the tree.

18. The system of claim 15, wherein the navigation module navigates a user in tree structures of data through reordering portions of the tree.

19. The system of claim 15, wherein the navigation module navigates a user in tree structures of data through suggesting a list of nodes from a sub-tree.

20. The system of claim 15, wherein the navigation module navigates a user in tree structures of data through auto-completing partial paths entered by the user.
